(19) United States
(12) Patent Application Publication
(10) Pub. No.: US 2024/0143398 A1
(43) Pub. Date: May 2, 2024

(54) RESOURCE ACCESS DECISION MANAGEMENT IN QUANTUM COMPUTING SYSTEMS

(71) Applicant: Red Hat, Inc., Raleigh, NC (US)

(72) Inventors: Leigh Griffin, Waterford (IE); Stephen Coady, Waterford (IE)

(21) Appl. No.: 17/975,179

(22) Filed: Oct. 27, 2022

(51) Int. Cl. G06F 9/50

(52) U.S. Cl. CPC G06F 9/5027

(57) ABSTRACT

A quantum computing system receives, from an access granting entity that grants access to a quantum computing resource, a request for information associated with a decision by the access granting entity whether to grant quantum computing resource access to a requesting entity. The quantum computing system obtains quantum validation information, wherein the quantum validation information is descriptive of one or more of characteristics of the requesting entity, characteristics of the quantum computing resource, a current state of a quantum computing device that implements the quantum computing resource, or a predicted state of the quantum computing device associated with access of the quantum computing resource by the requesting entity. The quantum computing system provides the quantum validation information to the access granting entity for the decision whether to grant quantum computing resource access to the requesting entity.

### BACKGROUND

Quantum computing systems utilize quantum bits (“qubits”) to implement quantum computing services. A qubit in superposition can be in multiple states simultaneously. Multiple qubits in superposition can be in an exponential number of states simultaneously, which is an advantage over classical bits when solving certain problems However, qubits are relatively difficult to produce, and as such, access to quantum computing services must be carefully managed.

### SUMMARY

Aspects of the present disclosure facilitate detailed decision making for granting or denying access to quantum computing resources. More particularly, aspects of the present disclosure can provide quantum validation information to an access granting entity within a quantum computing environment. By leveraging the quantum validation information, the access granting entity can make a more efficient decision as to whether to grant or deny quantum computing resource access to a requesting entity.

In one implementation, a method is provided. The method includes receiving, by a quantum computing system from an access granting entity that grants access to a quantum computing resource, a request for information associated with a decision by the access granting entity whether to grant quantum computing resource access to a requesting entity. The method includes obtaining quantum validation information, wherein the quantum validation information is descriptive of one or more of characteristics of the requesting entity, characteristics of the quantum computing resource, a current state of a quantum computing device that implements the quantum computing resource, and/or a predicted state of the quantum computing device associated with access of the quantum computing resource by the requesting entity. The method includes providing the quantum validation information to the access granting entity for the decision whether to grant quantum computing resource access to the requesting entity.

In another implementation, a quantum computing system is provided. The quantum computing system includes a memory a processor device. The processor is coupled to the memory to provide, to a quantum information entity, a request for information associated with a decision whether to grant a requesting entity access to a quantum computing resource, wherein the quantum computing resource is implemented by a quantum computing device. The processor is coupled to the memory to, responsive to providing the request for validation, receiving, from the quantum information entity, quantum validation information descriptive of one or more of the requesting entity, the quantum computing device, or the quantum computing resource. The processor is coupled to the memory to based at least in part on the quantum validation information, make a determination whether to grant the requesting entity access to the quantum computing resource.

In another implementation, a non-transitory computer-readable storage medium is provided. The non-transitory computer-readable storage medium includes executable instructions to cause a processor device to receive, by a quantum computing system from an access granting entity that grants access to a quantum computing resource, a request for information associated with a decision by the access granting entity whether to grant quantum computing resource access to a requesting entity. The non-transitory computer-readable storage medium includes executable instructions to cause a processor device to obtain quantum validation information, wherein the quantum validation information is descriptive of one or more of characteristics of the requesting entity, characteristics of the quantum computing resource, a current state of a quantum computing device that implements the quantum computing resource, and/or a predicted state of the quantum computing device associated with access of the quantum computing resource by the requesting entity. The non-transitory computer-readable storage medium includes executable instructions to cause a processor device to provide the quantum validation information to the access granting entity for the decision whether to grant quantum computing resource access to the requesting entity.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which examples may be practiced according to some implementations of the present disclosure.

FIG. 2 is a flowchart of a method for verification of access decisions for quantum computing resources according to some implementations of the present disclosure.

FIG. 3 is a simplified block diagram of the environment illustrated in FIG. 1 according to some implementations of the present disclosure.

FIG. 4 is a block diagram of the computing device suitable for implementing examples according to some implementations of the present disclosure.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context.

Quantum computing systems utilize qubits to implement quantum computing services. As used herein, a “qubit” may refer to a unit of quantum information, or a device that stores a unit of quantum information. As a newly emerging and substantially complex area of technology, quantum computing environments generally possess a limited quantity of qubits. As such, managing access to quantum computing resources of the quantum computing environment is of paramount importance (e.g., qubits, quantum computing services implemented with qubits, quantum processes, etc.).

A quantum bit (“qubit”) in superposition can be in multiple states simultaneously. Multiple qubits in superposition can be in an exponential number of states simultaneously, which is an advantage over classical bits when solving certain problems.

Computing systems conventionally implement access controls to limit access to certain computing resources (e.g., memory, processes, services, hardware devices, etc.). In some instances, computing systems will manage access to computing resources using role-based access controls (RBAC) based on a subject, such as a task or process; an action, such as a read action, a write action, a delete action, a generate action; and a resource, such as a file, an application programming interface, a database, or the like. Namely, access granting entities will determine whether to grant or deny access to a computing resources based on access policies. Access policies dictate whether an access requesting entity should be granted or denied access to a computing resource based on various factors (e.g., a role assigned to the access granting entity, etc.).

Within the context of a quantum computing system, a requesting entity may request access to quantum computing resources, which may include qubits or services/processes implemented via qubits. Access granting entities generally will determine whether to grant access to quantum computing resources based on access policies. For example, a policy may dictate that access requesting entities assigned a specific role are to be provided access to a quantum computing resource. Based on this policy, the access granting entity may provide access credentials to the requesting entity.

However, when making this decision, access granting entities lack critical information regarding the state of the quantum computing environment, characteristics of the requesting entity, characteristics of the requested quantum computing resource, etc. By failing to account for these factors, access granting entities may grant access to a quantum computing resource at an inopportune time, causing substantial degradation of quantum computing performance within the quantum computing system.

Accordingly, aspects of the present disclosure propose validation of quantum resource access decisions. In particular, an access granting entity can request information associated with a decision whether to grant quantum computing resource access to a requesting entity. In response, quantum validation information can be provided to the access granting entity that describes characteristics of the requesting entity (e.g., historic access data, a user associated with the entity, etc.), and a current and predicted state of the quantum computing resource (e.g., a predicted qubit temperature associated with access of the quantum computing resource, etc.).

For example, an access granting entity may make an initial decision to grant access to a quantum service based on access policies. The access granting entity may then request, and receive, quantum validation information. The information may indicate that granting access to the quantum service would cause an increase in temperature in the qubits that implement the quantum service that is above a threshold temperature. In response, the access granting entity can instruct the requesting entity to enter a queue for access, or to wait a period of time before attempting access. In such fashion, implementations of the present disclosure substantially reduce performance inefficiencies associated with policy-based access decisions.

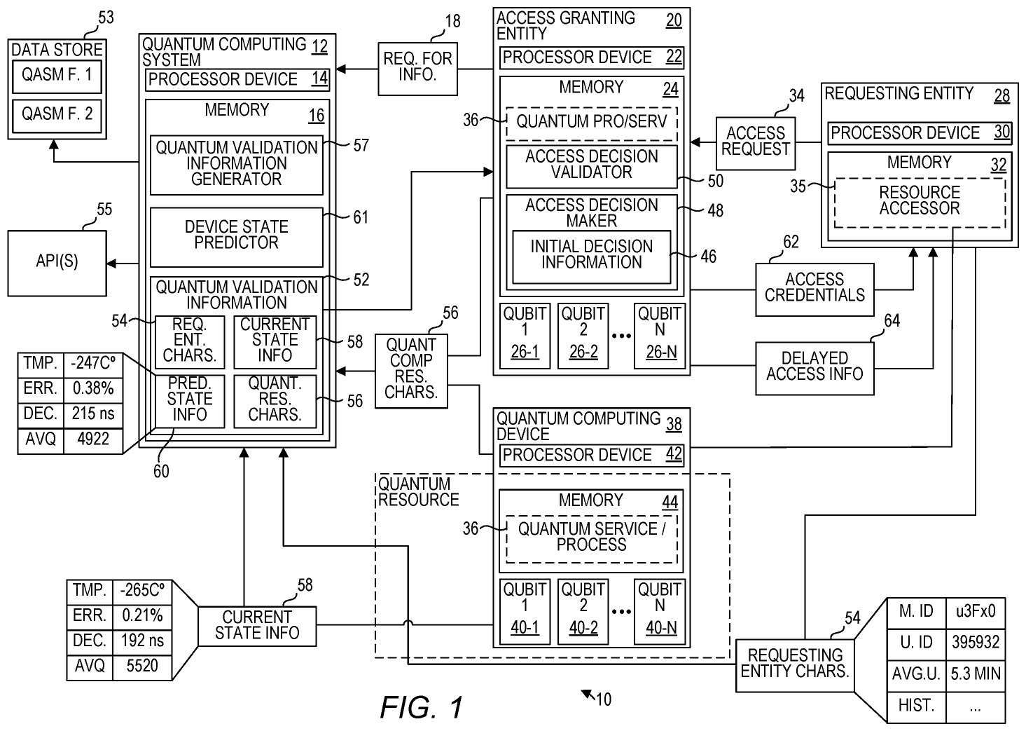

FIG. 1 is a block diagram of a quantum computing environment 10 in which examples may be practiced according to some implementations of the present disclosure. The quantum computing environment 10 includes a quantum computing system 12 which operates in a quantum computing environment 10 but can operate using classical computing principles or quantum computing principles. When using quantum computing principles, the quantum computing system 12 performs computations that utilize quantum-mechanical phenomena, such as superposition and entanglement. The quantum computing system 12 may operate under certain environmental conditions, such as at or near 0° Kelvin. When using classical computing principles, the quantum computing system 12 utilizes binary digits that have a value of either 1 or 0.

The quantum computing system 12 includes at least one processor device 14 and at least one memory 16. The memory 16 can be or otherwise include any device(s) capable of storing data, including, but not limited to, volatile memory (random access memory, etc.), non-volatile memory, storage device(s) (e.g., hard drive(s), solid state drive(s), etc.).

The quantum computing system 12 can receive a request for information 18 from an access granting entity 20. The access granting entity 20 can be, or otherwise include, any number of classical and/or quantum computing device(s). For example, the access granting entity can include a processor device 22 and a memory 24 as described with regards to the quantum computing system 12. In particular, the access granting entity 20 can operate in the quantum computing environment 10 but can operate using classical computing principles or quantum computing principles. When using quantum computing principles, the access granting entity 20 performs computations that utilize quantum-mechanical phenomena, such as superposition and entanglement. The access granting entity 20 may operate under certain environmental conditions, such as at or near 0° Kelvin. When using classical computing principles, the access granting entity 20 may utilize binary digits that have a value of either 1 or 0.

For example, in some implementations, the access granting entity 20 can include, or otherwise be communicatively coupled to, a plurality of qubits 26-1-26-N (generally, qubits 26). The number of qubits 26 could comprise hundreds or thousands of qubits 26. In addition, in some implementations, the access granting entity 20 may include a qubit registry which maintains information about the qubits 26, including, by way of non-limiting example, a total qubits counter that maintains count of the total number of qubits 26 implemented by the access granting entity 20, and a total available qubits counter that maintains count of the total number of qubits 26 that are currently available for allocation.

In some implementations, this qubit registry may also maintain qubit metadata, which comprises a plurality of qubit registry records, each of which maintains information about a corresponding qubit 26-1-26-N, such as, by way of non-limiting example, a field that contains an identifier of the corresponding qubit 26, a field that identifies whether the qubit is available for use or not available for use, and a field that identifies the type of the corresponding qubit 26, such as, by way of non-limiting example, a photonic qubit (P), a semiconductor qubit (S), or some other type of qubit.

As described previously, the access granting entity 20 can provide a request for information 18 to the quantum computing system 12 for information regarding a decision by the access granting entity 20 whether to grant quantum computing resource access to an requesting entity 28. The requesting entity 28 can include a processor device 30 and a memory 32 in the same manner as described with regards to the quantum computing system 12. For example, the requesting entity 28 may provide an access request 34 for a quantum computing resource (e.g., via a resource accessor 35, etc.) to the access granting entity 20.

In some implementations, the access granting entity 20 may make an initial decision 46 (e.g., using initial decision maker 48, etc.) to grant access to the quantum computing resource to the requesting entity 28. The access granting entity 20 may then provide a request for information 18 to validate the initial decision (e.g., using access decision validator 50, etc.). Alternatively, in some implementations, the access granting entity 20 may defer decision-making until the request for information 18 is fulfilled.

It should be noted that the quantum computing resource may be, or otherwise include, one or more qubits (e.g., qubits 26, qubits 40, etc.), quantum process and/or quantum service 36, etc. In particular, the quantum computing resource may be a quantum process or service 36 implemented using qubits 26. For example, the quantum computing resource may be a quantum service 36 that is implemented by the qubits 26. For another example, the quantum computing resource may be a set of qubits (e.g., qubits 26). For yet another example, the quantum computing resource may be a collection of quantum service(s)/process(es) 36, qubit(s) 26, etc.

In some implementations, the quantum computing resource may be provided or otherwise implemented by the access granting entity 20. Alternatively, in some implementations, the quantum computing resource may be provided or otherwise implemented using a quantum computing device 38. The quantum computing device 38 may exist within the quantum computing environment 10, and may process data via quantum and/or classical methods as described with regards to the quantum computing system 12. In some implementations, the quantum computing system 12 may be, or otherwise include, the quantum computing device 38. The quantum computing device 38 can include qubits 40-1-40-N as described with regards to qubits 26-1-26-N of the access granting entity 20, and can include a processor device 42 and a memory 44 as described with regards to quantum computing system 12.

The quantum computing system 12 can obtain quantum validation information 52. In some implementations, the quantum computing system 12 may obtain quantum validation information 52 from data store(s) 53 and/or API(s) 55, and/or may generate the quantum validation information 52 (e.g., using quantum validation information generator 57, etc.). In some implementations, the quantum validation information 52 can describe characteristics 54 of the requesting entity 28. In some implementations, the quantum computing system 12 may access data store 53 and/or application programming interface(s) (API(s)) 55 to obtain information that describes the characteristics 54 of the requesting entity 28. For example, the quantum validation information 52 may describe an identity of a user associated with the requesting entity 28. For another example, the quantum validation information 52 may describe prior access history associated with the requesting entity 28 (e.g., prior access interactions with the quantum computing resource in question, etc.). For yet another example, the quantum validation information 52 may describe physical and/or computational features of the requesting entity 28 (e.g., available processing resources, a geographic location, etc.).

Additionally, or alternatively, in some implementations, the quantum validation information 52 can describe characteristics 56 of the quantum computing resource. For example, the quantum computing resource may be a quantum computing service, and the characteristics 56 may indicate a quantity of qubits required for instantiation of the quantum computing service. For another example, if the quantum computing resource is a quantum process or service 36, the quantum validation information 52 may describe various aspects of the quantum process/service 36 (e.g., an intended input/output, an expected processing time, a cost associated with service access, etc.).

Additionally, or alternatively, in some implementations, the quantum validation information 52 may describe a current state 58 of the quantum computing resource. In particular, the quantum computing system 12 may obtain information descriptive of the current state 58 from the quantum computing device 38 or the access granting entity 20. For example, if the quantum computing resource is a set of qubits 26, the quantum validation information 52 may describe a current temperature metric indicative of a current temperature, current decoherence metric indicative of a current decoherence, current error rate metric indicative of a current error rate, etc. associated with the set of qubits 26. For another example, if the quantum computing resource is a quantum computing process/service 36, the quantum validation information 52 may describe a current cost associated with provision of the quantum computing process/service 36.

Additionally, or alternatively, in some implementations, the quantum validation information 52 may describe a predicted state 60 of the quantum computing resource. In particular, the quantum computing system 12 may leverage a device state predictor 61 to obtain the predicted state 60. For example, if the quantum computing resource is a set of qubits 26, the quantum validation information 52 may describe predicted state information 60 such as a predicted temperature metric indicative of a predicted temperature, decoherence metric indicative of a predicted decoherence, error rate metric indicative of a predicted error rate, etc. associated with the set of qubits 26. For another example, if the quantum computing resource is a quantum computing process/service 36, the quantum validation information 52 may describe a predicted state of the quantum process/service 36 such as a current cost associated with provision of the quantum computing process/service 36. More generally, the access granting entity 20 can evaluate a difference between a current state described by the information descriptive of the current state 58, and a predicted state described by predicted state information 60, to determine whether a predicted performance cost is greater than a threshold performance cost. For example, if a performance cost (e.g., an increase in qubit temperature, error rate, decoherence, etc.) is greater than a threshold, the access granting entity 20 can decide to deny access to the quantum computing resource.

In such fashion, the quantum validation information 52 can facilitate calculation of a performance cost associated with provision of access to the quantum computing resource by the access granting entity 20. For example, if the quantum validation information 52 describes a current temperature of qubits 26 and a predicted temperature of qubits 26 following access of the quantum computing resource, the access granting entity can more accurately determine whether to grant access to the quantum computing resource to the requesting entity 28. In such fashion, aspects of the present disclosure can substantially reduce performance inefficiencies associated with policy-based access provision.

As described previously, in some implementations, the quantum computing system 12 may obtain the quantum validation information from data store(s) 53 and/or API(s) 55. For example, the API 55 may be an API for a social media service that includes a profile for a user associated with the requesting entity 28. The quantum validation information 52 may describe requesting characteristics 54, and may be obtained from the API 55. For another example, the quantum computing resource may be a quantum service 36, and the data store 53 may be a data store for a code versioning system. The code versioning system data store 53 can include QASM files used to implement the quantum service 36. The quantum computing system 12 can obtain quantum validation information 52 from the data store 53 to determine a current and/or predicted state 58/60 based on the QASM file.

In some implementations, based on the quantum validation information 52, the access granting entity 20 can determine to grant quantum computing resource access to the access granting entity 20. For example, in some implementations, the access granting entity 20 can make an initial decision 46 to grant access to the requesting entity 28. The access granting entity 20 can then validate the initial decision 46 (e.g., via the access decision validator) based on the quantum validation information. Once the decision is validated, the access granting entity 20 can provide access credentials 62 to the requesting entity 28 for accessing the quantum computing resource. Alternatively, in some implementations, the access granting entity may defer a decision to grant access to the requesting entity 28, and then make the decision based on the quantum validation information 52.

More generally, in some implementations, the access granting entity can decide to grant access to the requesting entity 28, and to do so, can provide access credentials 62 to the requesting entity 28. The access credentials 62 can be any type or manner of information sufficient to authenticate the requesting entity 28 for access of the quantum computing resource. For example, the access credentials 62 may be an encoding (e.g., a hash, etc.) that expires after a certain period of time.

Alternatively, in some implementations, the access granting entity 20 may determine to deny or postpone quantum computing resource access to the requesting entity 28. For example, the access granting entity 20 may determine that granting access to the requesting entity 28 may cause a performance cost greater than a threshold cost. In response, the access granting entity 20 can send delayed access information 64 to the requesting entity 28.

In some implementations, the delayed access information 64 can include access credentials for delayed access to the quantum computing resource. For example, the access credentials for delayed access may only activate after a period of time has expired. For another example, the access credentials may only activate once a minimum performance threshold has been reached by the quantum computing resource (e.g., a qubit temperature falling under a certain temperature threshold, etc.).

Additionally, or alternatively, in some implementations, the delayed access information 64 can include information indicative of a period of time at which the quantum computing resource is accessible by the requesting entity 28. For example, the delayed access information 64 may indicate that the access requesting entity can access the quantum computing resource but must wait until a certain time of day. Additionally, or alternatively, in some implementations, the delayed access information 64 can include information indicative of a position of the requesting entity in a queue for access to the quantum computing resource. For example, the delayed access information 64 may include access credentials 62 for access of the quantum computing resource, but may indicate that the access credentials 62 will only activate after the access requesting entity 28 has reached the beginning of a queue for access to the quantum computing resource.

As such, it should be broadly understood that the delayed access information 64 can include information sufficient to grant access to the quantum computing resource at a time other than the current time at which the delayed access information 64 is provided to the requesting entity 28.

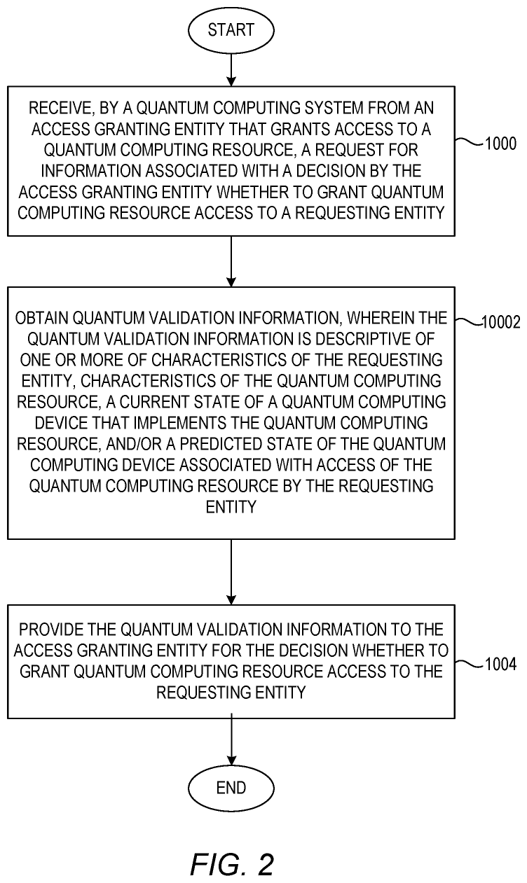

FIG. 2 is a flowchart of a method for verification of access decisions for quantum computing resources according to some implementations of the present disclosure. FIG. 2 will be discussed in conjunction with FIG. 1. The quantum computing system 12 receives, from an access granting entity 20 that grants access to a quantum computing resource, a request for information 18 associated with a decision 46 by the access granting entity 20 whether to grant quantum computing resource access to a requesting entity 28 (FIG. 2, block 1000). The quantum computing system 12 obtains quantum validation information 52. The quantum validation information 52 is descriptive of one or more of characteristics 54 of the requesting entity 28, characteristics 56 of the quantum computing resource, a current state 58 of a quantum computing device 38 that implements the quantum computing resource, or a predicted state 60 of the quantum computing device 38 associated with access of the quantum computing resource by the requesting entity 28 (FIG. 2, block 1002). The quantum computing system 12 provides the quantum validation information 52 to the access granting entity 20 for the decision whether to grant quantum computing resource access to the requesting entity 28 (FIG. 2, block 1004).

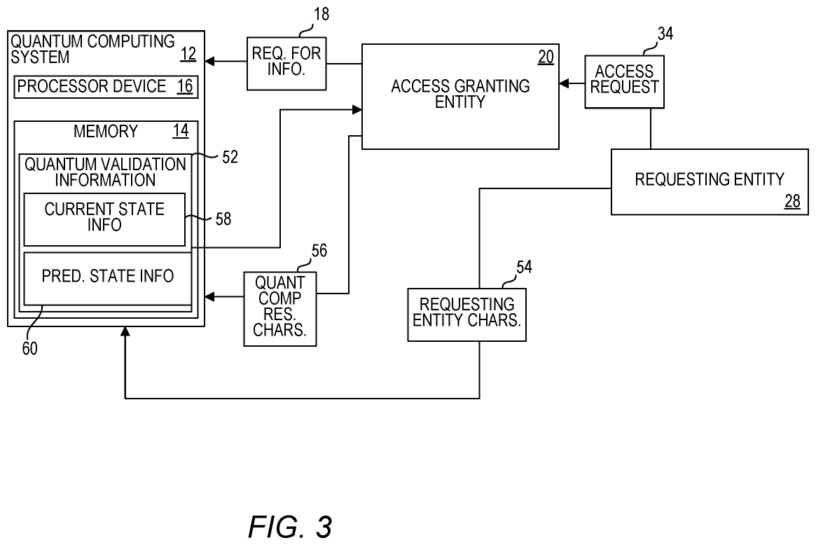

FIG. 3 is a simplified block diagram of the quantum computing environment 10 illustrated in FIG. 1 according to some implementations of the present disclosure. The quantum computing environment 10 includes the quantum computing system 12 which in turn includes the memory 16 and the processor device 14 coupled to the memory 16. The processor device 14 is to receive, from an access granting entity 20 that grants access to a quantum computing resource, a request for information 18 associated with a decision by the access granting entity 20 whether to grant quantum computing resource access to a requesting entity 28. The processor device 14 is further to obtain quantum validation information 52, wherein the quantum validation information 52 is descriptive of characteristics 54 of the requesting entity 28, characteristics 56, of the quantum computing resource, a current state 58 of the quantum computing resource, and/or a predicted state 60 of the quantum computing resource. The processor device 14 is further to provide the quantum validation information 52 to the access granting entity 20 for the decision whether to grant quantum computing resource access to the requesting entity 28.

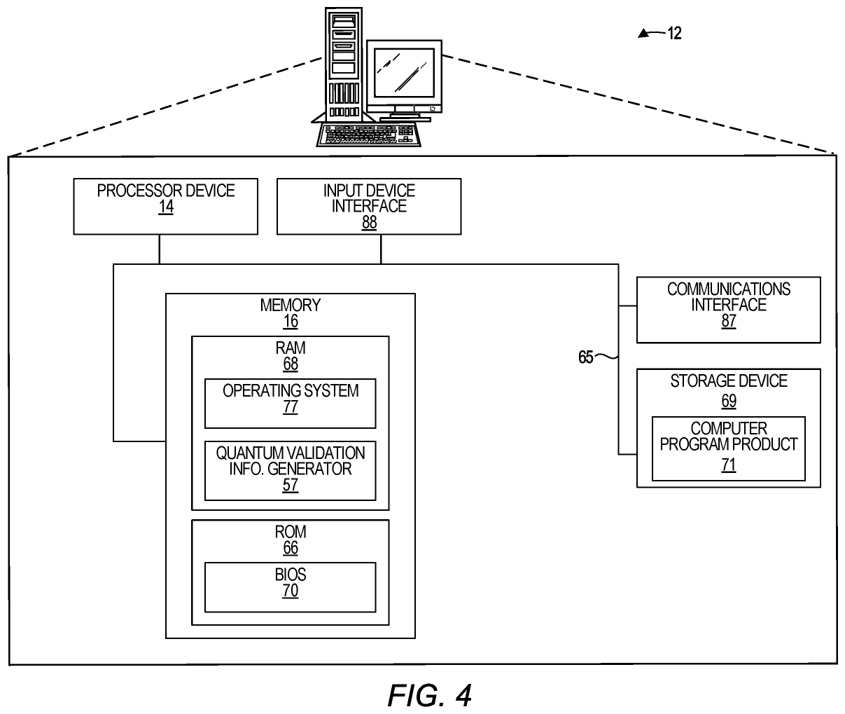

FIG. 4 is a block diagram of the quantum computing system 12 suitable for implementing examples according to some implementations of the present disclosure. The quantum computing system 12 may comprise any computing or electronic device capable of including firmware, hardware, and/or executing software instructions to implement the functionality described herein, such as a computer server, a desktop computing device, a laptop computing device, a smartphone, a computing tablet, or the like. The quantum computing system 12 includes the processor device 14, the system memory 16, and a system bus 65. The system bus 65 provides an interface for system components including, but not limited to, the system memory 16 and the processor device 14. The processor device 14 can be any commercially available or proprietary processor.

The system bus 65 may be any of several types of bus structures that may further interconnect to a memory bus (with or without a memory controller), a peripheral bus, and/or a local bus using any of a variety of commercially available bus architectures. The system memory 16 may include non-volatile memory 66 (e.g., read-only memory (ROM), erasable programmable read-only memory (EPROM), electrically erasable programmable read-only memory (EEPROM), etc.), and volatile memory 68 (e.g., random-access memory (RAM)). A basic input/output system (BIOS) 70 may be stored in the non-volatile memory 66 and can include the basic routines that help to transfer information between elements within the quantum computing system 12. The volatile memory 68 may also include a high-speed RAM, such as static RAM, for caching data.

The quantum computing system 12 may further include or be coupled to a non-transitory computer-readable storage medium such as the storage device 69, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 69 and other drives associated with computer-readable media and computer-usable media may provide non-volatile storage of data, data structures, computer-executable instructions, and the like.

A number of modules can be stored in the storage device 69 and in the volatile memory 68, including an operating system 77 and one or more program modules, such as the quantum validation information generator 57, which may implement the functionality described herein in whole or in part. All or a portion of the examples may be implemented as a computer program product 71 stored on a transitory or non-transitory computer-usable or computer-readable storage medium, such as the storage device 69, which includes complex programming instructions, such as complex computer-readable program code, to cause the processor device 14 to carry out the steps described herein. Thus, the computer-readable program code can comprise software instructions for implementing the functionality of the examples described herein when executed on the processor device 14. The processor device 14, in conjunction with the file quantum validation information generator 57 in the volatile memory 68, may serve as a controller, or control system, for the quantum computing system 12 that is to implement the functionality described herein.

An operator, such as a user, may also be able to enter one or more configuration commands through a keyboard (not illustrated), a pointing device such as a mouse (not illustrated), or a touch-sensitive surface such as a display device. Such input devices may be connected to the processor device 14 through an input device interface 88 that is coupled to the system bus 65 but can be connected by other interfaces such as a parallel port, an Institute of Electrical and Electronic Engineers (IEEE) 1394 serial port, a Universal Serial Bus (USB) port, an IR interface, and the like. The quantum computing system 12 may also include the communications interface 87 suitable for communicating with the network as appropriate or desired. The quantum computing system 12 may also include a video port configured to interface with a display device, to provide information to the user.

Individuals will recognize improvements and modifications to the preferred examples of the disclosure. All such improvements and modifications are considered within the scope of the concepts disclosed herein and the claims that follow.

What is claimed is:

1. A method comprising:
receiving, by a quantum computing system from an access granting entity that grants access to a quantum computing resource, a request for information associated with a decision by the access granting entity whether to grant quantum computing resource access to a requesting entity;
obtaining quantum validation information, wherein the quantum validation information is descriptive of one or more of:
characteristics of the requesting entity;
characteristics of the quantum computing resource;
a current state of a quantum computing device that implements the quantum computing resource; or
a predicted state of the quantum computing device associated with access of the quantum computing resource by the requesting entity; and
providing the quantum validation information to the access granting entity for the decision whether to grant quantum computing resource access to the requesting entity.

2. The method of claim 1, wherein obtaining the quantum validation information comprises obtaining quantum validation information descriptive of the current state of the quantum computing device and the predicted state of the quantum computing device associated with access of the quantum computing resource by the requesting entity.

3. The method of claim 2, wherein the current state of the quantum computing device comprises a current temperature metric for the quantum computing device, and the predicted state of the quantum computing device comprises a predicted temperature metric associated with access of the quantum computing resource by the requesting entity.

4. The method of claim 2, wherein the current state of the quantum computing device comprises a current decoherence metric for the quantum computing device, and the predicted state of the quantum computing device comprises a predicted decoherence metric associated with access of the quantum computing resource by the requesting entity.

5. The method of claim 2, wherein the current state of the quantum computing device comprises a current error rate metric for the quantum computing device, and the predicted state of the quantum computing device comprises a predicted error rate metric associated with access of the quantum computing resource by the requesting entity.

6. The method of claim 1, wherein obtaining the quantum validation information comprises obtaining quantum validation information descriptive of characteristics of the quantum computing resource, and wherein the characteristics of the quantum computing resource comprises a quantity of qubits required for instantiation of the quantum computing resource.

7. The method of claim 1, wherein obtaining the quantum validation information comprises accessing a data store and/or application programming interface (API) to obtain the quantum validation information.

8. The method of claim 7, wherein accessing the data store and/or API to obtain the quantum validation information comprises accessing a data store for a code versioning system that stores one or more QASM files that implement the quantum computing resource; and
wherein the quantum validation information comprises the one or more QASM files.

9. The method of claim 1, wherein the quantum computing resource comprises at least one of:
a quantum computing service;
a quantum computing process;
a quantum computing hardware device; or
one or more qubits.

10. A non-transitory computer-readable storage medium that includes executable instructions to cause a processor device of a quantum computing system to:
provide, to a quantum information entity, a request for information associated with a decision whether to grant a requesting entity access to a quantum computing resource, wherein the quantum computing resource is implemented by a quantum computing device;
responsive to providing the request for validation, receiving, from the quantum information entity, quantum validation information descriptive of one or more of the requesting entity, the quantum computing device, or the quantum computing resource; and
based at least in part on the quantum validation information, make a determination whether to grant the requesting entity access to the quantum computing resource.

11. The non-transitory computer-readable storage medium of claim 10, wherein receiving the quantum validation information comprises receiving quantum validation information comprising a predicted performance cost to the quantum computing device associated with access of the quantum computing resource; and
wherein making the determination whether to grant to the requesting entity access to the quantum computing resource comprises determining whether the predicted performance cost is greater than a threshold performance cost.

12. The non-transitory computer-readable storage medium of claim 10, wherein the quantum validation information is descriptive of one or more of:
a predicted temperature metric associated with the quantum computing device;
a predicted decoherence metric associated with the quantum computing device;
a predicted error rate for the quantum computing device; or
a quantity of qubits available to the quantum computing device.

13. The non-transitory computer-readable storage medium of claim 10, wherein making the determination comprises, based at least in part on the quantum validation information, making a determination to grant the requesting entity access to the quantum computing resource; and
wherein the executable instructions are further to cause the processor device of the quantum computing system to send, to the requesting entity, access credentials that grant access to the quantum computing resource.

14. The non-transitory computer-readable storage medium of claim 10, wherein making the determination comprises, based at least in part on the quantum validation information, making a determination to not grant the requesting entity access to the quantum computing resource.

15. The non-transitory computer-readable storage medium of claim 14, wherein the executable instructions are further to cause the processor device of the quantum computing system to send, to the requesting entity, delayed access information that comprises one or more of:
access credentials for delayed access to the quantum computing resource;
information indicative of a period of time at which the quantum computing resource is accessible by the requesting entity; or
information indicative of a position of the requesting entity in a queue for access to the quantum computing resource.

16. A quantum computing system, comprising:
a memory; and
a processor device coupled to the memory to:
receive, by a quantum computing system from an access granting entity that grants access to a quantum computing resource, a request for information associated with a decision by the access granting entity whether to grant quantum computing resource access to a requesting entity;
obtain quantum validation information, wherein the quantum validation information is descriptive of one or more of:
characteristics of the requesting entity;
characteristics of the quantum computing resource;
a current state of a quantum computing device that implements the quantum computing resource; or
a predicted state of the quantum computing device associated with access of the quantum computing resource by the requesting entity; and
provide the quantum validation information to the access granting entity for the decision whether to grant quantum computing resource access to the requesting entity.

17. The quantum computing system of claim 16, wherein obtaining the quantum validation information comprises obtaining quantum validation information descriptive of the current state of the quantum computing device and the predicted state of the quantum computing device associated with access of the quantum computing resource by the requesting entity.

18. The quantum computing system of claim 17, wherein the current state of the quantum computing device comprises a current temperature metric for the quantum computing device, and the predicted state of the quantum computing device comprises a predicted temperature metric associated with access of the quantum computing resource by the requesting entity.

19. The quantum computing system of claim 17, wherein the current state of the quantum computing device comprises a current decoherence metric for the quantum computing device, and the predicted state of the quantum computing device comprises a predicted decoherence metric associated with access of the quantum computing resource by the requesting entity.

20. The quantum computing system of claim 17, wherein the current state of the quantum computing device comprises a current error rate metric for the quantum computing device, and the predicted state of the quantum computing device comprises a predicted error rate metric associated with access of the quantum computing resource by the requesting entity.
